(19) United States
(12) Patent Application Publication
(10) Pub. No.: US 2014/0124349 A1
(43) Pub. Date: May 8, 2014

(54) POWER WINDOW SWITCH

(71) Applicant: ALPS ELECTRIC CO., LTD., Tokyo (JP)

(72) Inventor: Satoru Konno, Miyagi-Ken (JP)

(21) Appl. No.: 14/047,445

(22) Filed: Oct. 7, 2013

(30) Foreign Application Priority Data
Nov. 2, 2012 (JP) 2012-242266

(51) Int. Cl. H01H 13/76

(52) U.S. Cl. CPC H01H 13/76
USPC 200/5 A

(57) ABSTRACT

A power window switch includes: an upper case including a plurality of openings; a plurality of operation portions which are respectively positioned in the openings and are supported to be oscillated; a plurality of drive bodies which are arranged on a lower side of the operation portions and are lifted and lowered according to the oscillation operations of the operation portions; an elastic sheet including a plurality of pressing portions that are pressed according to the lifting and lowering operations of the drive bodies; a board disposed on a lower side of the elastic sheet; and a lower case. In the board, at least a first board and a second board are electrically connected, the second board includes a plurality of contact portions corresponding to the pressing portions, and conduction of the contact portions can be switched according to the operations of the pressing portions.

### CLAIM OF PRIORITY

This application claims benefit of Japanese Patent Application No. 2012-242266 filed on Nov. 2, 2012, which is hereby incorporated by reference in its entirety.

### BACKGROUND OF THE DISCLOSURE

1. Field of the Disclosure

The present disclosure relates to a power window switch used for an operation of a power window of a vehicle, and particularly to a power window switch capable of reducing manufacturing cost.

2. Description of the Related Art

Recently, a power window switch used to operate a power window of a vehicle needs to function in a plurality of types of variations even when being used in the same type of vehicle. This is because of a difference in the number of windows or options of the vehicle, for example, in a case where an option is an electric sunroof, there is a difference due to the increase in the number of components for the operation thereof, and the like. Japanese Unexamined Patent Application Publication No. 2007-308102 discloses a known power window switch.

Hereinafter, a power window switch 900 described in Japanese Unexamined Patent Application Publication No. 2007-308102 will be described using FIG. 12. FIG. 12 is an exploded perspective view illustrating the configuration of the power window switch 900 described in Japanese Unexamined Patent Application Publication No. 2007-308102.

The power window switch 900 described in Japanese Unexamined Patent Application Publication No. 2007-308102 includes an upper case 910 that includes four openings 910a arranged in two lines, longitudinally and laterally, four seesaw knobs 911 that are respectively supported in the openings 910a so as to be oscillated, a plurality of drive bodies 912 that are lifted and lowered by the oscillation operations of the seesaw knobs 911, a lower case 913 which is integrated with the upper case 910 to constitute a housing, a circuit board 914 placed on the lower case 913, a rubber sheet 915 attached to the circuit board 914, and an illumination mechanism constituted by a light guide body 901 and a chip-shaped LED 916 mounted on the circuit board 914.

However, in the power window switch 900 described in Japanese Unexamined Patent Application Publication No. 2007-308102, the circuit board 914 has a configuration in which electronic components such as an integrated circuit (IC) are arranged on a single plate-shaped substrate and contact portions, wiring patterns, and the like are provided thereon. Therefore, when the components of the power window switch are changed due to a difference in the option of the vehicle or the like, there is a need to change the size of the circuit board 914 or change the layout on the circuit board 914 according to the change. The circuit board 914 has the electronic components mounted on the plate-shaped substrate. The plate-shaped substrate is more expensive than a film-shaped substrate and requires an increase in cost when the size thereof is increased, and the cost for preparing various types of circuit boards 914 is needed. In addition, an evaluation test needs to be performed whenever the circuit board 914 is changed, and thus the cost corresponding to the evaluation test is needed. As such, in the configuration, it is difficult to reduce the production cost.

### SUMMARY

JA power window switch includes: an upper case which includes a plurality of openings; a plurality of operation portions which are respectively positioned in the plurality of openings and are supported to be oscillated; a plurality of drive bodies which are arranged on a lower side of the plurality of operation portions and are lifted and lowered according to the oscillation operations of the plurality of operation portions; an elastic sheet which is disposed on a lower side of the plurality of drive bodies, includes a plurality of pressing portions that are pressed according to the lifting and lowering operations of the plurality of drive bodies, and is made of an elastic member; a board which is disposed on a lower side of the elastic sheet; and a lower case which is disposed on a lower side of the board. In the board, at least a first board and a second board formed in a film shape are electrically connected. The second board includes a plurality of contact portions corresponding to the plurality of pressing portions, and conduction of the plurality of contact portions is able to be switched according to the operations of the plurality of pressing portions.

From the above description, according to the aspects of the present invention, the power window switch having reduced manufacturing cost can be provided.

### BRIEF DESCRIPTION OF THE DRAWINGS

FIG. 1 is a perspective view illustrating the external form of a power window switch in a first embodiment;

FIG. 2 is an exploded perspective view illustrating the configuration of the power window switch in the first embodiment;

FIGS. 3A and 3B are perspective views illustrating the external form of a first board;

FIGS. 4A to 4C are diagrams illustrating a second board;

FIGS. 5A and 5B are diagrams illustrating the external form of a lower case;

FIGS. 6A to 6C are diagrams illustrating an elastic sheet;

FIGS. 7A and 7B are perspective views illustrating a drive body;

FIGS. 8A and 8B are perspective views illustrating an operation portion;

FIGS. 9A to 9C are diagrams illustrating the external form of an upper case;

FIGS. 10A and 10B are diagrams illustrating a board disposed in the lower case;

FIGS. 11A and 11B are schematic diagrams illustrating the operations of the power window switch; and

FIG. 12 is an exploded perspective view illustrating the configuration of a power window switch 900 described in Japanese Unexamined Patent Application Publication No. 2007-308102.

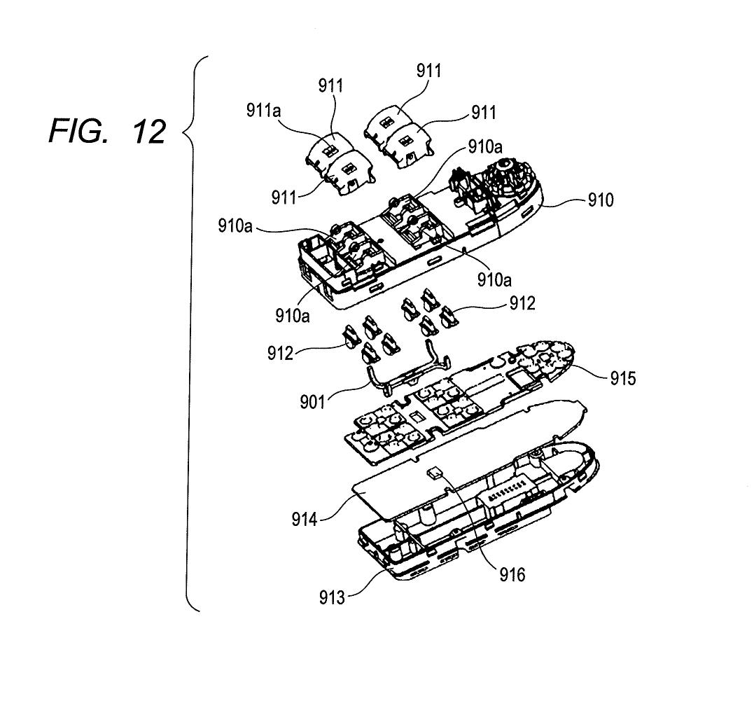

### DESCRIPTION OF THE EXAMPLARY EMBODIMENTS

### First Embodiment

Hereinafter, a power window switch 100 in a first embodiment will be described.

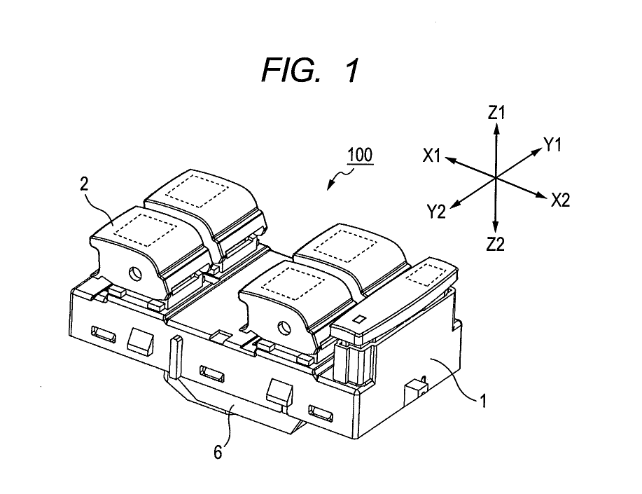

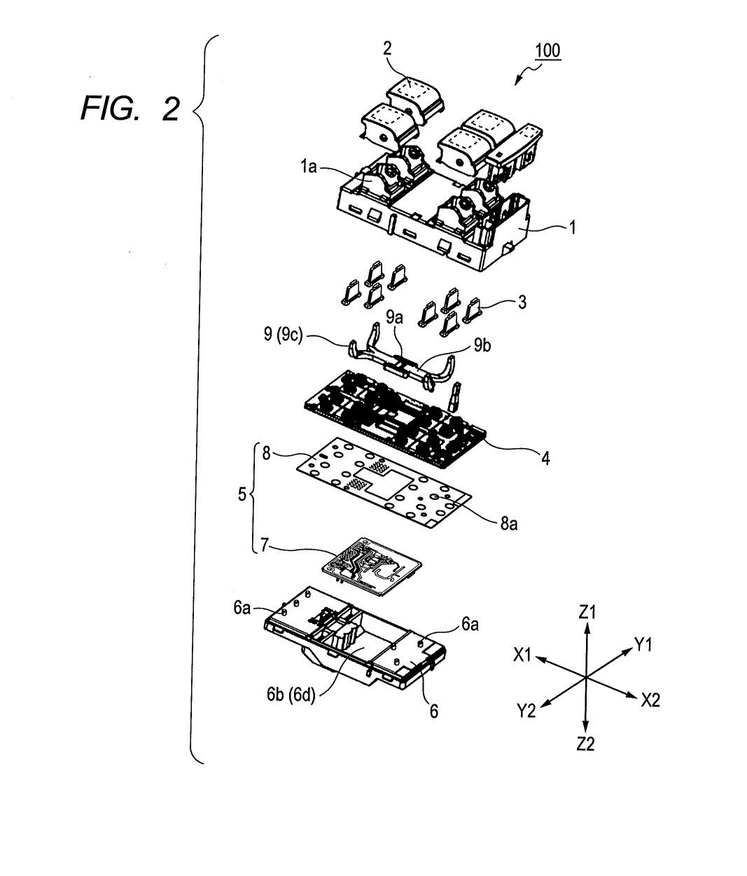

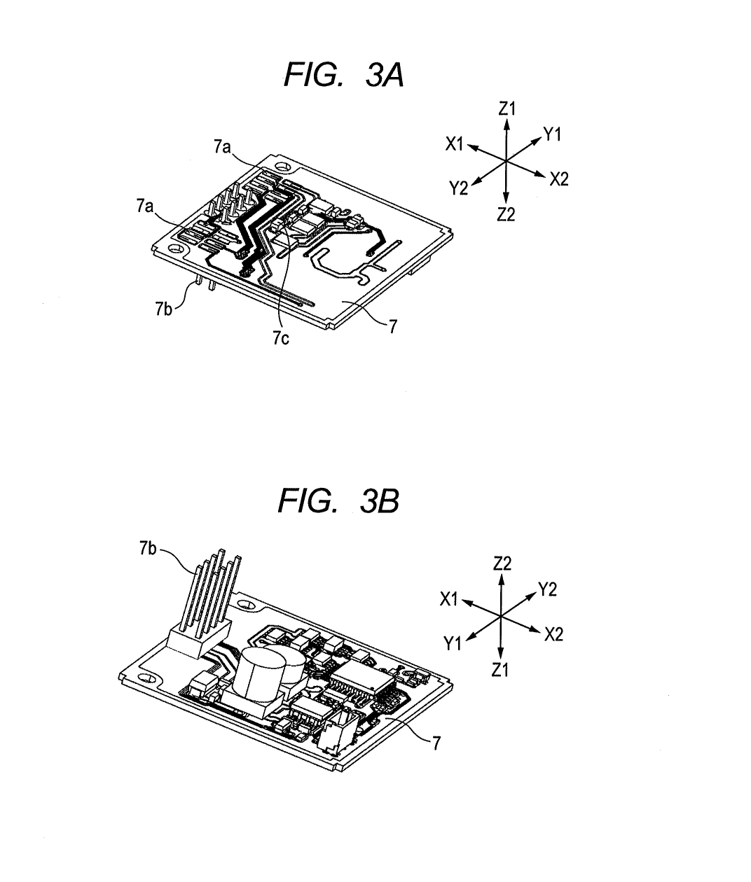

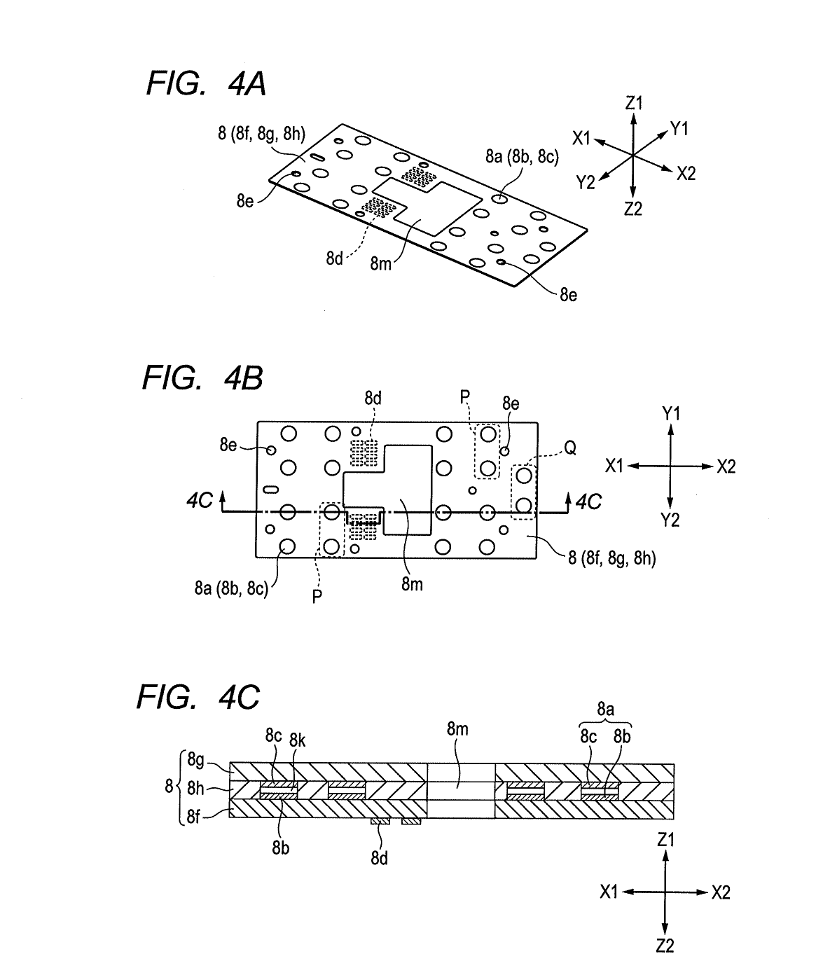

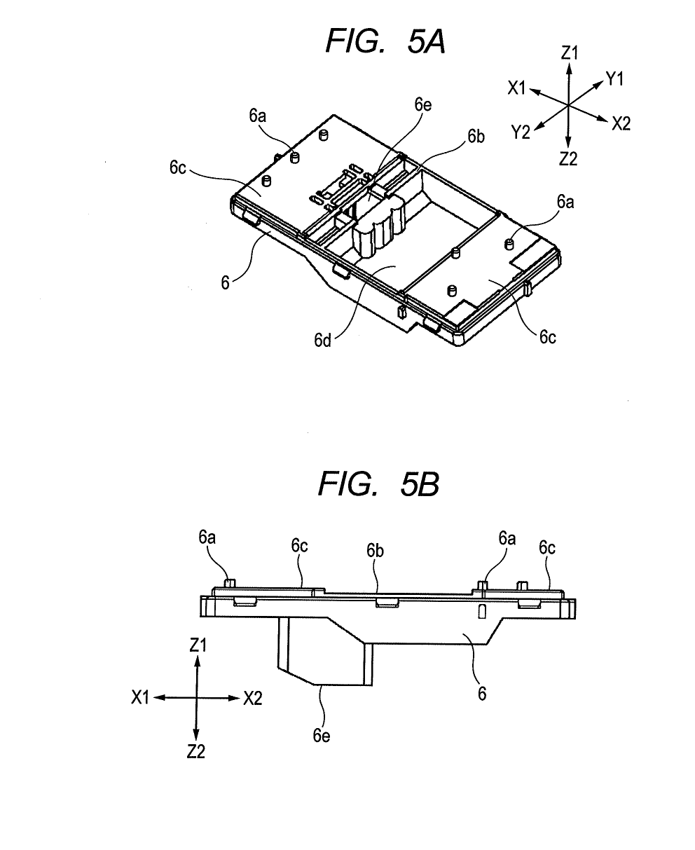

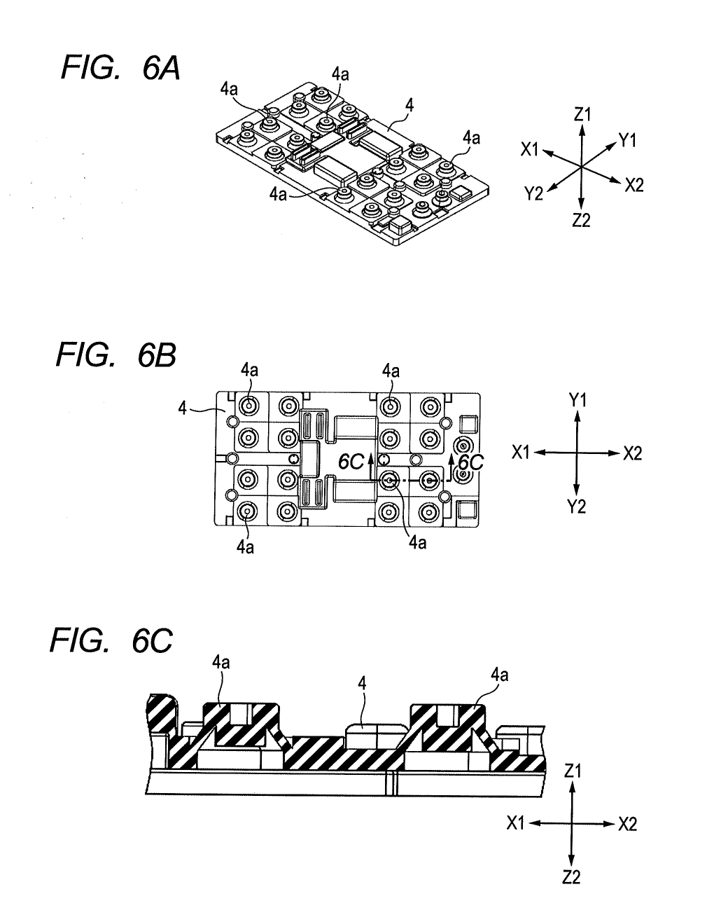

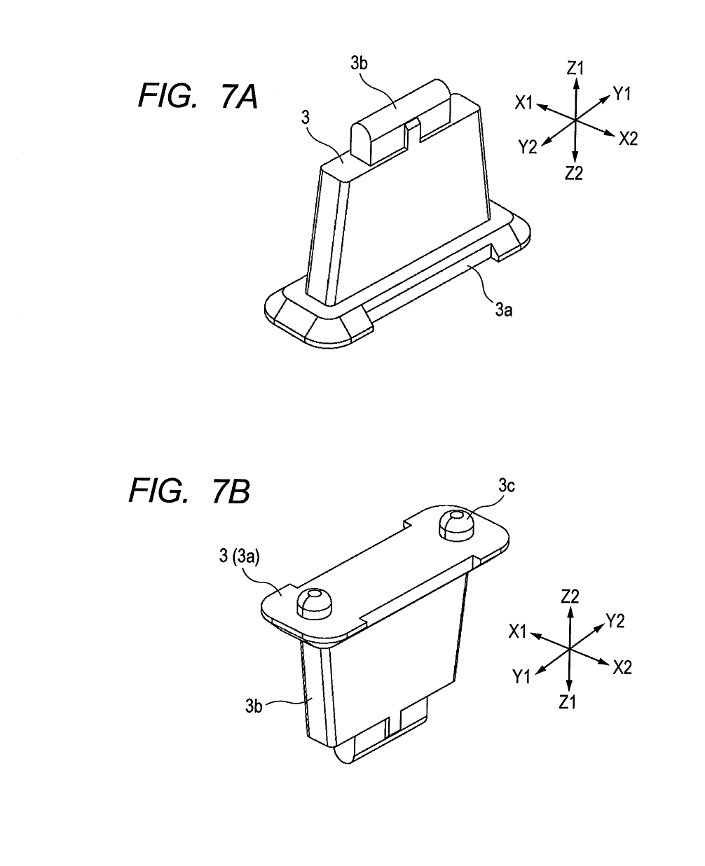

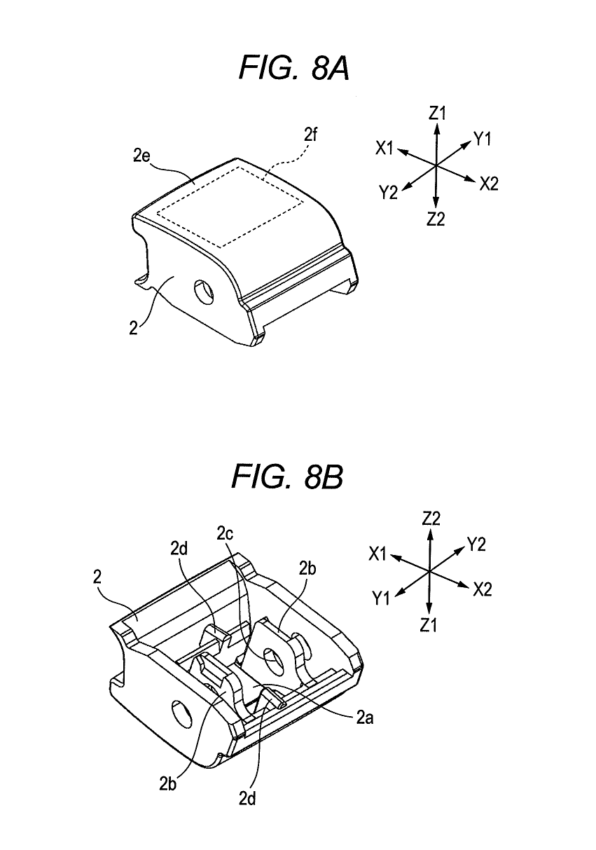

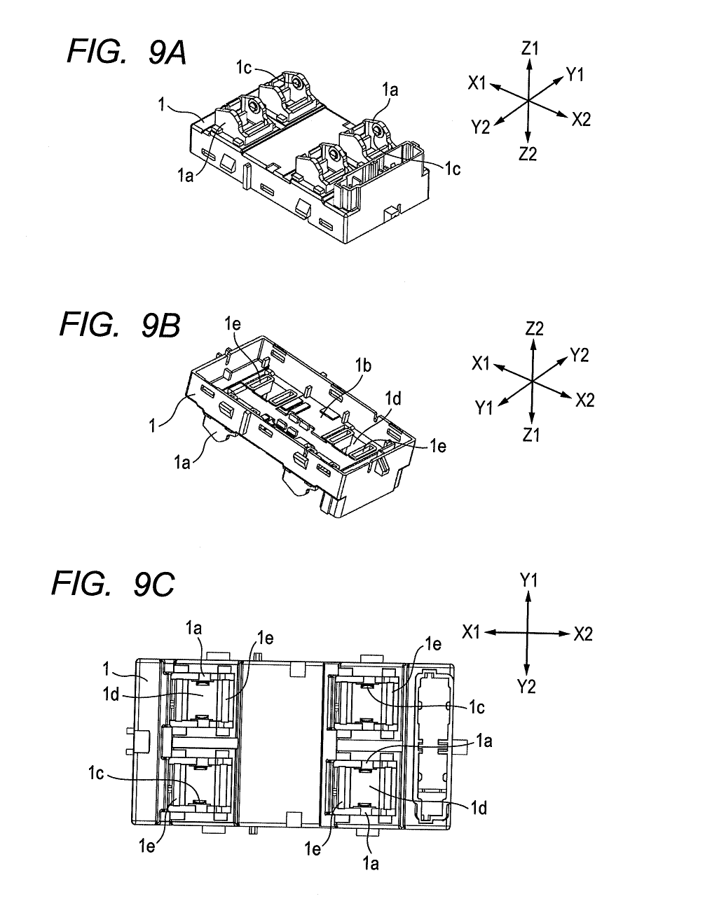

First, the configuration of the power window switch 100 in this embodiment will be described using FIGS. 1 to 9C. FIG. 1 is a perspective view illustrating the external form of the power window switch 100 in the first embodiment. FIG. 2 is an exploded perspective view illustrating the configuration of the power window switch 100 in the first embodiment. FIGS. 3A and 3B are perspective views illustrating the external form of a first board 7, in which FIG. 3A is a perspective view illustrating a state of the first board 7 viewed from above, and FIG. 3B is a perspective view illustrating a state of the first board 7 viewed from below. FIGS. 4A to 4C are diagrams illustrating a second board 8, in which FIG. 4A is a perspective view illustrating the external form of the second board 8, FIG. 4B is a plan view illustrating a state of the second board 8 viewed in a Z1 direction illustrated in FIG. 4A, and FIG. 4C is a cross-sectional view schematically illustrating a cross-section A-A illustrated in FIG. 4B. FIGS. 5A and 5B are diagrams illustrating the external form of a lower case 6, in which FIG. 5A is a perspective view illustrating the external form of the lower case 6, and FIG. 5B is a plan view illustrating a state of the lower case 6 viewed in a Y2 direction illustrated in FIG. 5A. FIGS. 6A to 6C are diagrams illustrating an elastic sheet 4, in which FIG. 6A is a perspective view illustrating the external form of the elastic sheet 4, FIG. 6B is a plan view illustrating a state of the elastic sheet 4 viewed in a Z1 direction illustrated in FIG. 6A, and FIG. 6C is a cross-sectional view schematically illustrating a cross-section B-B illustrated in FIG. 6B. FIGS. 7A and 7B are perspective views illustrating a drive body 3, in which FIG. 7A is a perspective view illustrating a state of the drive body 3 viewed from above, and FIG. 7B is a perspective view illustrating a state of the drive body 3 viewed from below. FIGS. 8A and 8B are perspective views illustrating an operation portion 2, in which FIG. 8A is a perspective view illustrating a state of the operation portion 2 viewed from above, and FIG. 8B is a perspective view illustrating a state of the operation portion 2 viewed from below. FIGS. 9A to 9C are diagrams illustrating the external form of an upper case 1, in which FIG. 9A is a perspective view illustrating a state of the upper case 1 viewed from above, FIG. 9B is a perspective view illustrating a state of the upper case 1 viewed from below, and FIG. 9C is a plan view illustrating a state of the upper case 1 viewed in a Z1 direction illustrated in FIG. 9A.

As illustrated in FIG. 2, the power window switch 100 includes the upper case 1, a plurality of the operation portions 2, a plurality of the drive bodies 3, the elastic sheet 4, a board 5, the lower case 6, and a light guide 9, and as illustrated in FIG. 1, is a power window switch in which the four operation portions 2 are arranged.

As illustrated in FIG. 2, the board 5 includes the first board 7 and the second board 8 which is formed in a film shape, and the first board 7 and the second board 8 are electrically connected to be used. The first board 7 is, for example, formed by using a glass epoxy substrate. In addition, as illustrated in FIGS. 3A and 3B, on both surfaces of the board 5, wiring made of a metallic foil plate is provided and various electronic components which start from an illumination member 7c are mounted. In addition, the first board 7 includes a first connection portion 7a, which can be electrically connected to the second board 8 on the upper surface (the surface on a Z1 direction side), and an outside connection terminal 7b which can be electrically connected to the outside is provided on the lower surface side to protrude. As illustrated in FIGS. 4A to 4C, the second board 8 is formed in a sheet shape having flexibility, and for example, is formed by using polyethylene terephthalate (PET). The second board 8 includes a plurality of contact portions 8a. In the first embodiment, the contact portions 8a are provided at sixteen points, and the two points as shown in a P section form a pair to constitute a contact of a switch mechanism. Each of the contact portions 8a includes a stationary contact portion 8b and a movable contact portion 8c, which can be electrically connected to each other and form a pair. In addition, in the first embodiment, an operation switch which performs an operation (referred to as an A operation) other than an opening and closing operation of the power window is formed to be integrated, and thus the contact portions 8a for the A operation as shown in a Q section are also formed at two points. Further, as illustrated in FIG. 4C, the second board 8 includes a first sheet board 8f provided with the stationary contact portion 8b, a second sheet board 8g provided with the movable contact portion 8c, and a spacer board 8h provided with operation holes 8k which are positioned to correspond to the contact portions 8a. The stationary contact portion 8b is formed on the upper surface (the surface on the Z1 direction side) of the first sheet board 8f, and the movable contact portion 8c is formed under the lower surface (the surface on the Z2 direction side) of the second sheet board 8g. The second sheet board 8g is disposed to overlap the upper side of the first sheet board 8f with the spacer board 8h interposed therebetween, and at this time, the stationary contact portion 8b and the movable contact portion 8c are disposed to oppose each other with the operation hole 8k interposed therebetween. In this manner, the second board 8 which is formed by overlapping the second sheet board 8g on the upper side of the first sheet board 8f with the spacer board 8h interposed therebetween includes a second connection portion 8d which can be electrically connected to the first connection portion 7a of the first board 7 on the lower surface (the surface on the Z2 direction side of the first sheet board 8f). In addition, at least two through-holes 8e are formed in the second board 8, and in the first embodiment, six through-holes 8e are formed. The second board 8 includes an insertion hole 8m into which various electronic components mounted on the first board 7 can be inserted. Further, at least one of the first connection portion 7a and the second connection portion 8d is made of a conductive ink having flexibility, and in the first embodiment, the second connection portion 8d is made of the conductive ink.

The lower case 6 is formed of a synthetic resin material. In addition, as illustrated in FIGS. 5A and 5B, the lower case 6 is formed in an approximately cuboid shape. The lower case 6 has a depth, which is approximately the same as the thickness of the first board 7, at the center portion of the upper surface (the surface on the Z1 direction side) and has a concave portion 6b formed therein, in which the first board 7 can be disposed. In the concave portion 6b, an accommodation portion 6d which can accommodate the various electronic components mounted on the first board 7 and a terminal insertion hole 6e into which the outside connection terminal 7b included in the first board 7 can be inserted are formed. In addition, flat surface portions 6c which include flat surfaces formed to be connected to the concave portion 6b are formed on the upper surface of the lower case 6, and in the flat surface portions 6c, six cylindrical projections 6a which correspond to the through-holes 8e included in the second board 8 and can be inserted into the through-holes 8e are formed.

The elastic sheet 4 is made of an elastic member having light-transmitting properties. In addition, as illustrated in FIGS. 6A to 6C, the elastic sheet 4 is formed in an approximately rectangular plate shape. The elastic sheet 4 includes a plurality of pressing portions 4a, which can abut on the contact portions 8a of the board 5 (the second board 8), and in the first embodiment, are formed at sixteen points according to the number of the contact portions 8a. As illustrated in FIG. 6C, the pressing portion 4a protrudes upward (in the Z1 direction), is formed to have a hollow shape on the lower side (the Z2 direction side) thereof, and is thus formed to deform in the pressed direction when pressed from above and to return to its original shape when the pressure is released. In addition, the sheet thickness of a part in the elastic sheet 4, which corresponds to the illumination member 7c mounted on the board 5 is adjusted depending on the luminance, color, and the like of light emitted by the illumination member 7c. In addition, in the first embodiment, the part corresponding to the illumination member 7c mounted on the board 5 is near the center portion of the elastic sheet 4 and is formed to be thinner than the surrounding parts.

The light guide 9 is made of a synthetic resin material having light-transmitting properties. In addition, as illustrated in FIG. 2, the light guide 9 is formed in an approximately bar shape. At the center portion of the light guide 9, a light entrance portion 9a through which the light emitted by the illumination member 7c mounted on the board 5 can enter the light guide 9 is formed, and light guide portions 9b are formed to extend outward (in the X1-X2 direction) from the light entrance portion 9a. The tip end side of the light guide portion 9b that extends outward is bifurcated and extends upward (in the Z2 direction) to form light exit portions 9c. Light that enters the light guide 9 from the light entrance portion 9a passes through the light guide portion 9b, and thus can exit from the light exit portion 9c to the outside of the light guide 9.

The drive body 3 is made of a synthetic resin material. In addition, as illustrated in FIGS. 7A and 7B, the drive body 3 is formed in an approximately rectangular plate shape. The drive body 3 includes a base portion 3a formed in a flat plate shape, and includes a sliding portion 3b formed on the upper surface (the surface on the Z1 direction side) of the base portion 3a to protrude upward in a plate shape. In addition, the drive body 3 includes pressing protrusions 3c formed on both end sides in the longitudinal direction (the Y1-Y2 direction) of the lower surface (the surface of the Z2 direction side) of the base portion 3a to protrude in a cylindrical shape.

The operation portion 2 is made of a synthetic resin material. In addition, as illustrated in FIGS. 8A and 8B, the operation portion 2 is formed in an approximately cuboid shape. The operation portion 2 opens toward the lower side (the Z2 direction side), and has a hollow portion 2a formed therein in a hollow shape. In the hollow portion 2a, two bearing portions 2b formed in a wall shape along the X1-X2 direction are arranged in parallel. The bearing portions 2b are arranged to be separated from the inner walls on the Y1-Y2 direction side of the hollow portion 2a, and bearing holes 2c are respectively provided in the vicinities of the center portions of the bearing portions 2b. In addition, in the inner walls on the X1-X2 direction side of the hollow portion 2a between the bearing portions 2b, drive portions 2d are respectively formed to protrude in the X1-X2 direction in a wall shape. In addition, the upper surface (the surface on the Z1 direction side) of the operation portion 2 is an operation surface 2e which receives a user's operation, and a portion of the operation surface 2e is an illumination portion 2f which is formed of a synthetic resin material having light-transmitting properties and is provided with a design or the like which shows an image of, for example, a window glass of a vehicle.

The upper case 1 is made of a synthetic resin material. In addition, as illustrated in FIGS. 9A to 9C, the upper case 1 is formed in an approximately cuboid shape. The upper case 1 has a hollow shape that opens toward the lower side (the Z2 direction side), and includes a storage portion 1b formed therein to store the other components. The upper surface (the surface on the Z1 direction side) of the upper case 1 includes a plurality of openings 1a in which the operation portions 2 can be disposed. The openings 1a have cross-sections formed in a rectangular tube shape, and are arranged to be lined up in two rows in the Y1-Y2 direction and lined up in two rows in the X1-X2 direction. In the inner walls of the opening 1a, which oppose each other in the Y1-Y2 direction, shaft projections 1c which protrude in a cylindrical shape are respectively formed to oppose each other. The shaft diameter of the shaft protrusion 1c has such a size that can be inserted into the bearing hole 2c of the operation portion 2. In addition, a light guide hole 1d connected to the storage portion 1b is formed in the bottom surface of the inside of the opening 1a, and on the X1-X2 direction sides with the light guide hole 1d interposed therebetween, guide holes 1e into which the sliding portions 3b of the drive body 3 can be inserted are respectively provided.

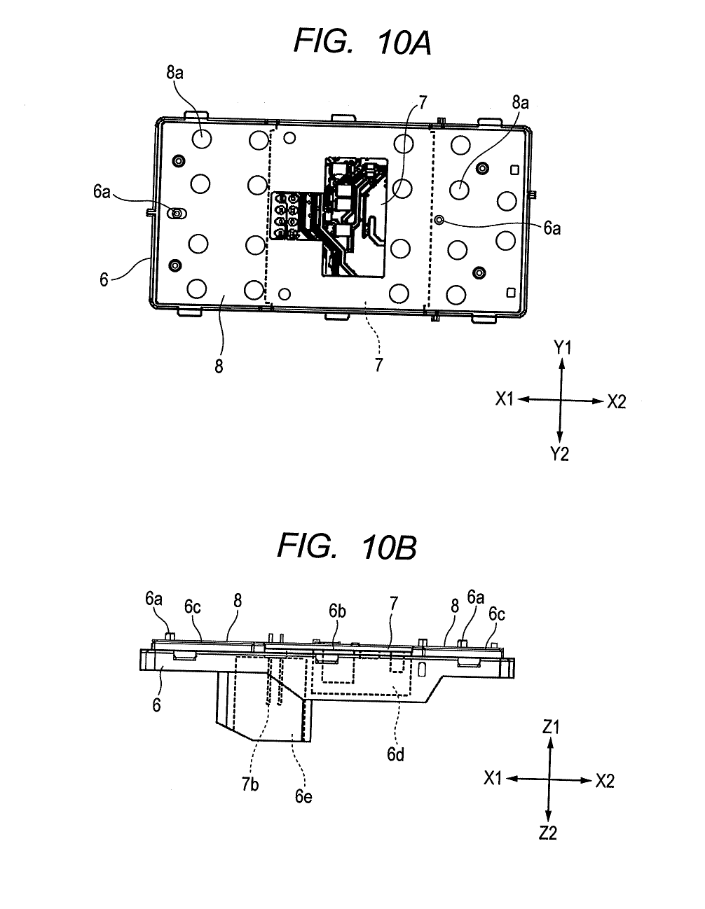

Next, the structure of the power window switch 100 will be described using FIGS. 1, 2, 10A, and 10B. FIGS. 10A and 10B are diagrams illustrating the board 5 disposed in the lower case 6, in which FIG. 10A is a plan view illustrating a state of the board 5 disposed in the lower case 6 and viewed from above, and FIG. 10B is a plan view illustrating a state of the board 5 disposed in the lower case 6 and viewed in the Y2 direction side illustrated in FIG. 10A. In addition, in FIGS. 1 and 2, some detailed parts of each component may not be denoted by reference numerals. The detailed parts of each component are shown in the corresponding diagram associated with each component.

As illustrated in FIGS. 1 and 2, the operation portions 2 are respectively positioned in the plurality of openings 1a formed in the upper case 1. At this time, the opening 1a is accommodated in the hollow portion 2a of the operation portion 2, and the bearing portion 2b of the operation portion 2 is inserted into the opening 1a to oppose the inner wall of the opening 1a having the shaft protrusion 1c so that the shaft protrusion 1c and the bearing hole 2c provided in the bearing portion 2b are engaged with each other. Therefore, the operation portion 2 is supported to be oscillated about the shaft protrusion 1c as the center. At this time, the guide hole 1e is disposed under the drive portion 2d provided in the operation portion 2.

The plurality of drive bodies 3 are arranged on the lower side of the plurality of operation portions 2 in a state where the sliding portions 3b are inserted into the guide holes 1e. The drive bodies 3 are disposed at the positions where the tip end portions of the sliding portions 3b can abut on the drive portions 2d of the operation portions 2, and are disposed to be guided by the guide holes 1e and to be lifted and lowered (in the Z1-Z2 direction) according to the oscillation operations of the plurality of operation portions 2.

In addition, the light guide 9 is disposed on the lower side of the upper case 1. At this time, the light exit portions 9c are respectively inserted into the light guide holes 1d of the upper case 1, and are disposed at the positions which face the rear surface of the operation surface 2e of the operation portion 2.

The elastic sheet 4 is disposed on the lower side of the plurality of drive bodies 3. In addition, the pressing portions 4a of the elastic sheet 4 are arranged at the positions where the pressing portions 4a can be operated according to the lifting and lowering operations of the plurality of drive bodies 3 to correspond to the respective drive bodies 3. In addition, in the first embodiment, the two pressing portions 4a are disposed for the single drive body 3, and can be pressed by the pressing protrusions 3c provided at the two points in the base portion 3a of the drive body 3.

The board 5 is disposed on the lower side of the elastic sheet 4. The board 5 is formed of the first board 7 and the second board 8, and the second board 8 is disposed to overlap the first board 7 so that the plurality of contact portions 8a are positioned to correspond to the plurality of pressing portions 4a and the second connection portions 8d oppose the first connection portions 7a. At this time, the contact portions 8a of the board 5 are arranged at the points corresponding to the pressing portions 4a of the elastic sheet 4 and are arranged to come into contact with the pressing portions 4a according to the operation of the pressing portions 4a. In addition, various electronic components are mounted on both surfaces of the first board 7, and the illumination member 7c which is one of the various electronic components is mounted on the side on which the first connection portion 7a is disposed and is disposed at the position which faces the elastic sheet 4 from the insertion hole 8m of the second board 8 and opposes the light entrance portion 9a of the light guide 9 with the elastic sheet 4 interposed therebetween.

The lower case 6 is disposed on the lower side of the board 5. As illustrated in FIGS. 10A and 10B, the first board 7 is disposed in the concave portion 6b of the lower case 6 so that the outside connection terminal 7b is inserted into the terminal insertion hole 6e. In addition, various components mounted on the side of the first board 7 on which the outside connection terminal 7b is disposed are accommodated in the accommodation portion 6d formed in the concave portion 6b. In addition, the second board 8 is disposed to overlap the first board 7 and the flat surface portions 6c of the lower case 6, and the projections 6a provided in the flat surface portions 6c are inserted into the corresponding through-holes 8e. In addition, as illustrated in FIG. 10A, in a plan view in the Z1 direction, at least a part of the plurality of contact portions 8a formed in the second board 8 is disposed over the outer side of the first board 7.

By arranging the components as such and locking the upper case 1 and the lower case 6 together as illustrated in FIG. 1, the power window switch 100 in which the components are held is formed. In addition, as the upper case 1 and the lower case 6 are locked together, the elastic sheet 4 is pressed against the upper case 1 and the first board 7 and the second board 8 come into further pressure contact with each other by the elastic sheet 4 such that the first connection portion 7a and the second connection portion 8d are electrically connected to each other. As the first connection portion 7a and the second connection portion 8d are electrically connected to each other, the first board 7 and the second board 8 function as the board 5.

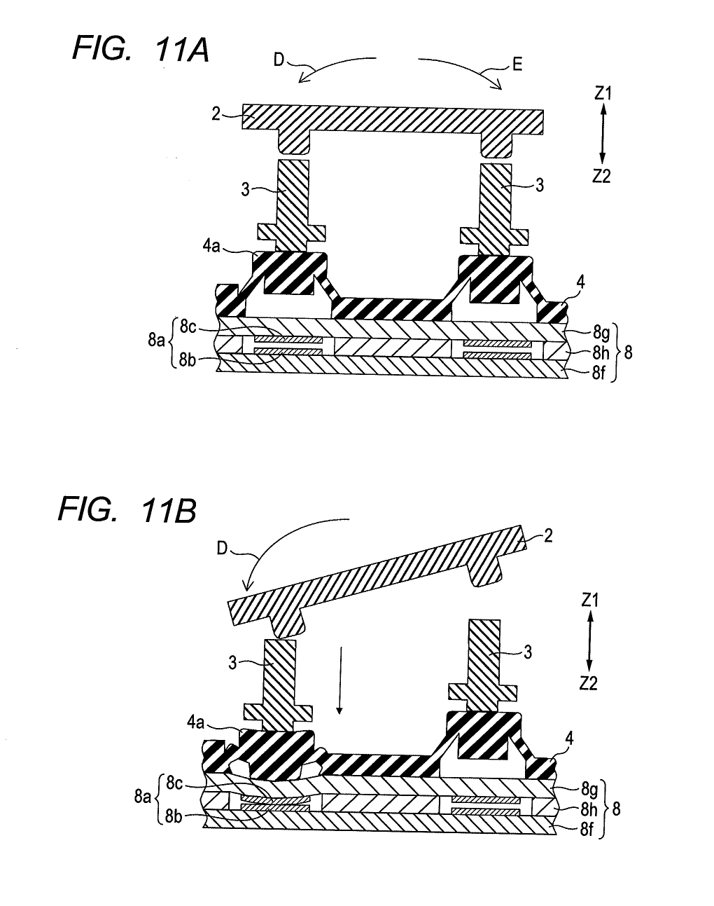

Next, the operations of the power window switch 100 will be described using FIGS. 2, 11A, and 11B. FIGS. 11A and 11B are schematic diagrams illustrating the operations of the power window switch 100. FIG. 11A is a schematic diagram illustrating an initial state where the operation portion 2 is not operated, and FIG. 11B is a schematic diagram illustrating a state where the operation portion 2 is operated. In addition, in FIGS. 11A and 11B, for facilitating the description, the positional relationship, the magnitude relationship, and the like of the components are different from those in practice, and illustrations of some components are omitted.

As illustrated in FIG. 11A, in the initial state where the operation portion 2 is not operated, the stationary contact portion 8b and the movable contact portion 8c are arranged to be separated at positions where they can come into contact with each other, and the stationary contact portion 8b and the movable contact portion 8c are in a state of being electrically disconnected.

From the initial state illustrated in FIG. 11A, for example, as illustrated in FIG. 11B, when the operation portion 2 is tilted in the D direction, the drive body 3 which abuts on the operation portion 2 is moved downward (in the Z2 direction). The drive body 3 that is moved downward abuts on the two corresponding pressing portions 4a of the elastic sheet 4, and the pressing portions 4a are respectively bent in the pressed direction to abut on the upper side of the contact portions 8a of the second board 8.

When the pressing portions 4a abut on the upper side of the contact portion 8a, since the second board 8 has flexibility, the movable contact portion 8c is moved downward by the downward operation of the pressing portion 4a, the movable contact portion 8c and the stationary contact portion 8b come into contact with each other such that the movable contact portion 8c and the stationary contact portion 8b are in a state of being electrically connected. In addition, when the operation of the operation portion 2 is stopped, the operation portion 2, the drive body 3, and the elastic sheet 4 are returned to the initial state by the elastic force of the elastic sheet 4, and the second board 8 is also returned to the initial state by the restoring force of the second board 8 such that the stationary contact portion 8b and the movable contact portion 8c are separated and enter the state of being electrically disconnected. In addition, even in a case where the operation portion 2 is tilted in the E direction shown in FIG. 11A, the same operation is performed. In this manner, according to the operations of the plurality of pressing portions 4a linked to the operation of the operation portion 2, the states of electrical connection (conduction) between the stationary contact portions 8b and the movable contact portions 8c of the plurality of contact portions 8a are switched to achieve the function of the power window switch. For example, the power window switch of the driver's seat may be set to perform an opening operation in a case where the operation portion 2 is tilted in the D direction and the power window switch of the driver's seat may be set to perform a closing operation in a case where the operation portion 2 is tilted in the E direction in use.

In addition, as illustrated in FIG. 2, when the illumination member 7c which is disposed at the position that opposes the light entrance portion 9a of the light guide 9 with the elastic sheet 4 of the board 5 interposed therebetween emits light in the direction in which the light entrance portion 9a is disposed, since the elastic sheet 4 has light-transmitting properties, the light passes through the elastic sheet 4 and enters the light guide 9 from the light entrance portion 9a. The light that enters the light guide 9 passes through the light guide portions 9b, reaches the light exit portions 9c, and exits from the light exit portions 9c to the outside of the light guide 9. Since the light exit portions 9c are disposed under the corresponding operation portions 2, the light that exits from the light exit portions 9c to the outside of the light guide 9 passes through the illumination portion 2f of the operation portion 2 and exits to the outside of the operation portion 2. As the light exits to the outside of the operation portion 2, the illumination portion 2f of the operation surface 2e is illuminated.

Hereinafter, effects in this embodiment will be described.

The power window switch 100 of this embodiment is a power window switch including: the upper case 1 which includes the plurality of openings 1a; the plurality of operation portions 2 which are respectively positioned in the plurality of openings 1a and are supported to be oscillated; the plurality of drive bodies 3 which are arranged on the lower side of the plurality of operation portions 2 are lifted and lowered according to the oscillation operations of the plurality of operation portions 2; the elastic sheet 4 which is disposed on the lower side of the plurality of drive bodies 3, includes the plurality of pressing portions 4a that are pressed according to the lifting and lowering operations of the plurality of drive bodies 3, and is made of an elastic member; the board 5 which is disposed on the lower side of the elastic sheet 4; and the lower case 6 which is disposed on the lower side of the board 5. In the board 5, at least the first board 7 and the second board 8 formed in a film shape are electrically connected. The second board 8 includes the plurality of contact portions 8a corresponding to the plurality of pressing portions 4a, and conduction of the plurality of contact portions 8a can be switched according to the operations of the plurality of pressing portions 4a.

Accordingly, since the board 5 includes the first board 7 and the second board 8 and the second board 8 includes the plurality of contact portions 8a corresponding to the plurality of pressing portions 4a, the second board 8 corresponds to a part in which the layout or the like is changed due to a difference in the option of a vehicle, and a part which can be used in common regardless of the option of the vehicle can be integrated in the first board 7. Accordingly, since the first board 7 can be used in common regardless of the option of the vehicle, (versatility is enhanced, and thus a reduction in the manufacturing cost is possible. In addition, the film-shaped substrate is cheaper than a plate-shaped substrate. A further reduction in cost can be achieved by forming the first board 7 which is widely used and is a plate-shaped board to have required minimum dimensions, and a further reduction in cost can be achieved by forming the second board 8 as a film shaped board compared to a case where a plate-shaped board corresponds to each of variations. Therefore,) there is an advantage that the power window switch 100 capable of reducing the manufacturing cost can be provided.

In addition, in the power window switch 100 of this embodiment, the first board 7 includes the first connection portion 7a at the upper surface thereof. The second board 8 includes the second connection portion 8d at the lower surface thereof. The second board 8 is disposed to overlap the first board 7 so that the second connection portion 8d and the first connection portion 7a oppose each other. The first board 7 and the second board 8 come into pressure contact with each other by the elastic sheet 4 such that the first connection portion 7a and the second connection portion 8d are electrically connected.

Accordingly, since the first board 7 and the second board 8 come into pressure contact with each other to be fixed and the first connection portion 7a and the second connection portion 8d are electrically connected, there is an advantage that a connection component such as a connector is not necessary, and due to the simple configuration, the manufacturing cost can be reduced.

In addition, in the power window switch 100 of this embodiment, at least two through-holes 8e are formed in the second board 8, and the projections 6a, which are inserted into the through-holes 8e, are formed in any of the upper case 1 and the lower case 6. In addition, in this embodiment, the projections 6a are formed in the lower case 6.

Accordingly, since the projection 6a is disposed to be inserted into the through-hole 8e of the second board 8, there is an advantage that the second board 8 can be easily and precisely disposed at a predetermined position.

In addition, in the power window switch 100 of this embodiment, the lower case 6 includes the concave portion 6b formed to have approximately the same thickness of the first board 7 and the flat surface portion 6c formed at the flat surface connected to the concave portion 6b. The first board 7 is disposed in the concave portion 6b, and the second board 8 is disposed on the first board 7 and the flat surface portion 6c.

Accordingly, since the first board 7 is disposed in the concave portion 6b, the power window switch 100 can be thinned. In addition, since the flat surface portion 6c and the first board 7 form substantially the same flat surface, the second board 8 can be held in a flat surface shape. Accordingly, the rear surface side of the second board 8 is received by the flat surface portion 6c, and thus a uniform pressure is applied to the second board 8 according to the operation of the operation portion 2. Therefore, there is an advantage that undesirable stress concentration is less likely to occur, a long life span can be achieved, and the switching of the conduction of the contact portion 8a can be more accurately performed.

In addition, in the power window switch 100 of this embodiment, the contact portion 8a includes the stationary contact portion 8b and the movable contact portion 8c. The second board 8 includes the first sheet board 8f that includes the stationary contact portion 8b and the second sheet board 8g that includes the movable contact portion 8c. The stationary contact portion 8b and the movable contact portion 8c are disposed to be separated, and the movable contact portion 8c is moved by the operation of the pressing portion 4a such that the movable contact portion 8c and the stationary contact portion 8b are able to come into contact with each other.

Accordingly, since the stationary contact portion 8b and the movable contact portion 8c are formed as a wiring pattern or the like in the second board 8, there is an advantage that low cost can be achieved compared to, for example, a case where the movable contact portion 8c is configured as an additional member made of a metal plate material.

In addition, in the power window switch 100 of this embodiment, at least one of the first connection portion 7a and the second connection portion 8d is made of a conductive ink.

Accordingly, since at least one of the first connection portion 7a and the second connection portion 8d is made of the conductive ink, when the first board 7 and the second board 8 come into pressure contact with each other to be fixed, due to the flexibility of the conductive ink, the first connection portion 7a and the second connection portion 8d are more reliably allowed to come into contact with each other through the surfaces. Therefore, there is an advantage that the first board 7 and the second board 8 are electrically connected more stably.

In addition, in the power window switch 100 of this embodiment, only the second connection portion 8d is formed of the conductive ink.

Accordingly, the first connection portion 7a is also formed of a metallic foil plate to be integrated into the lands for the various electronic components provided in the first board 7, and thus a printing process of the conductive ink is simplified, thereby achieving a further reduction in cost. In addition, since the second connection portion 8d is formed of the conductive ink, electrical connection, which is stable at a level having no problems, can be obtained. Therefore, the power window switch in which low cost can be achieved and the electrical connection between the first board 7 and the second board 8 is stable can be provided.

In addition, in the power window switch 100 of this embodiment, when the operation portion 2 is operated, the two contact portions 8a combined in the P section shown in FIG. 4 are pressed via the drive body 3.

Accordingly, at least one of the contact portions 8a is conductive, and thus the power window switch can be operated. Even when one of the contact portions 8a is not conductive for any reason, the power window switch can be operated as the other contact portion 8a is conductive. Therefore, compared to a case where the power window switch is operated by only a single contact portion 8a, the opening and closing operation of the power window switch can be more reliably performed.

In addition, in the power window switch 100 of this embodiment, the light emitted by the illumination member 7c passes through the elastic sheet 4 made of the synthetic resin material having light-transmitting properties and then enters the light guide 9.

Accordingly, by changing the sheet thickness, tone, or the like of the elastic sheet 4, the brightness of the illuminated point can be adjusted.

As described above, while the power window switch according to the embodiment of the present invention has been described in detail, the present invention is not limited to the embodiment, and various modifications can be made without departing from the gist of the present invention. For example, the following modifications can be embodied, and the modified embodiments also belong to the technical scope of the present invention.

(1) In the first embodiment, the board 5 is constituted by the single first board 7 and the single second board 8. However, for example, a plurality of second boards 8 may be configured by dividing the second board 8 in two boards and electrically connecting the boards in the vicinity of the opposing end portions of the first board 7. Accordingly, the degree of freedom of the layout is increased.
(2) In the first embodiment, the second board 8 is formed by interposing the spacer board 8h between the first sheet board 8f and the second sheet board 8g. However, the first sheet board 8f and the second sheet board 8g may be formed as a board having a single continuous sheet shape (referred to as a board Z) and by folding the board Z, the spacer board 8h may be interposed therebetween. The first sheet board 8f and the second sheet board 8g can be collectively manufactured, and a further reduction in cost can be achieved.
(3) In the first embodiment, the board 5 is configured by electrically connecting the first board 7 formed in a plate shape and the second board 8 formed in a film shape. However, the first board 7 may also be formed as a film-shaped board as long as there is no problem with the use of the product. By employing the film-shaped board which is cheaper than the plate-shaped board, the power window switch can be provided at lower cost.
(4) In the first embodiment, the projections 6a are provided in the lower case 6. However, the projections 6a may also be provided in the upper case 1.
(5) In the first embodiment, as illustrated in FIGS. 8A and 8B, the shape of the operation surface 2e is formed in a curved surface shape having a tilted end side. However, the shape thereof may also be changed to a shape in consideration of a touching sense or operability of the operation portion 2.

It should be understood by those skilled in the art that various modifications, combinations, sub-combinations and alterations may occur depending on design requirements and other factors insofar as they are within the scope of the appended claims of the equivalents thereof.

What is claimed is:

1. A power window switch, comprising:
an upper case which includes a plurality of openings;
a plurality of operation portions which are respectively positioned in the plurality of openings and are supported to be oscillated;
a plurality of drive bodies which are arranged on a lower side of the plurality of operation portions and are lifted and lowered according to the oscillation operations of the plurality of operation portions;
an elastic sheet which is disposed on a lower side of the plurality of drive bodies, includes a plurality of pressing portions that are pressed according to the lifting and lowering operations of the plurality of drive bodies, and is made of an elastic member;
a board which is disposed on a lower side of the elastic sheet; and
a lower case which is disposed on a lower side of the board,
wherein, in the board, at least a first board and a second board formed in a film shape are electrically connected, and
wherein the second board includes a plurality of contact portions corresponding to the plurality of pressing portions, and conduction of the plurality of contact portions can be switched according to the operations of the plurality of pressing portions.

2. The power window switch according to claim 1,
wherein:
the first board includes a first connection portion at an upper surface thereof,
the second board includes a second connection portion at a lower surface thereof,
the second board is disposed to overlap the first board so that the second connection portion and the first connection portion oppose each other, and
the first board and the second board come into pressure contact with each other by the elastic sheet such that the first connection portion and the second connection portion are electrically connected.

3. The power window switch according to claim 1,
wherein at least two through-holes are formed in the second board, and projections, which are inserted into the through-holes, are formed in any of the upper case and the lower case.

4. The power window switch according to claim 1,
wherein:
the lower case includes a concave portion formed to have approximately the same thickness as the first board and a flat surface portion formed at a flat surface connected to the concave portion, and
the first board is disposed in the concave portion, and the second board is disposed on the first board and the flat surface portion.

5. The power window switch according to claim 1,
wherein:
the contact portion includes a stationary contact portion and a movable contact portion,
the second board includes a first sheet board that includes the stationary contact portion and a second sheet board that includes the movable contact portion, and
the stationary contact portion and the movable contact portion are disposed to be separated, and as the movable contact portion is moved by the operation of the pressing portion, the movable contact portion and the stationary contact portion are able to come into contact with each other.

6. The power window switch according to claim 2,
wherein at least one of the first connection portion and the second connection portion is made of a conductive ink.
